(19) United States
(12) Patent Application Publication
(10) Pub. No.: US 2014/0260801 A1
(43) Pub. Date: Sep. 18, 2014

(54) SORTING MINED MATERIAL

(71) Applicants: Grant Ashley Wellwood, Pheasant Creek (AU); John Clarence Box, Perth (AU)

(72) Inventors: Grant Ashley Wellwood, Pheasant Creek (AU); John Clarence Box, Perth (AU)

(73) Assignee: TECHNOLOGICAL RESOURCES PTY. LIMITED, Brisbane, QLD (AU)

(21) Appl. No.: 14/233,013

(22) PCT Filed: Jul. 30, 2012
(86) PCT No.: PCT/AU2012/000901

§ 371 Date: Mar. 19, 2014

(30) Foreign Application Priority Data
Jul. 28, 2011 (AU) 2011903013

(51) Int. Cl. C22B 1/00; B07C 5/02; B07C 5/34

(52) U.S. Cl. CPC C22B 1/00; B07C 5/34; B07C 5/02
USPC 75/392; 209/552; 209/3.1

(57) ABSTRACT

A method for sorting mined material in a sorting apparatus is disclosed. The method includes supplying particles of a mined material onto a conveyor belt (5), transporting the particles on the conveyor belt past a detection assembly (9, 13) and assessing the particles, and separating the particles based on the assessment into an accepts stream and a rejects stream at a discharge end of the belt using a separator assembly (29). The method also includes controlling the arrangement of particles so that there is an ordered arrangement of particles on the belt to optimise the throughput of particles through the sorting apparatus.

### TECHNICAL FIELD

The present invention relates to a method and an apparatus for sorting mined material.

The term “mined” material is understood herein to include metalliferous material and non-metalliferous material. Iron-containing and copper-containing ores are examples of metalliferous material. Coal is an example of a non-metalliferous material. The term “mined” material is understood herein to include, but is not limited to, (a) run-of-mine material and (b) run-of-mine material that has been subjected to at least primary crushing or similar size reduction after the material has been mined and prior to being sorted. The mined material includes mined material that is in stockpiles.

The present invention relates particularly, although by no means exclusively, to a method and an apparatus for sorting mined material for subsequent processing to recover valuable material, such as valuable metals, from the mined material.

The present invention also relates to a method and an apparatus for recovering valuable material, such as valuable metals, from a mined material that has been sorted as described above.

The present invention relates particularly, although by no means exclusively, to a method and an apparatus for sorting a low grade mined material at high throughputs.

### BACKGROUND ART

The applicant is developing an automated sorting method and apparatus for mined material.

In general terms, the method of sorting mined material being developed by the applicant includes the following steps:

(a) exposing particles of mined material to electromagnetic radiation,

(b) detecting and assessing particles on the basis of composition (including grade) or texture or another characteristic of the particles, and

(c) physically separating particles based on the assessment in step (b).

Automated ore sorting systems known to the applicant are limited to low throughput systems. The general approach used in these low throughput sorting systems is to convey ore particles through sorting apparatus on a horizontal belt. While horizontal conveyor belts are a proven and effective approach for particles greater than 10 mm at throughputs up to around 200 t/h, the conveyor belts are unable to cater for the larger throughputs 500-1000 t/h needed to realise the economies of scale required for many applications in the mining industry such as sorting low grade ore having particle sizes greater than 10 mm.

The above references to the background art do not constitute an admission that the art forms a part of the common general knowledge of a person of ordinary skill in the art. The above references are also not intended to limit the application of the apparatus and method as disclosed herein.

### SUMMARY OF THE DISCLOSURE

The present invention is based on a realisation that one limitation of known horizontal belt systems is that the standard practice of loading belts in a random fashion results in relatively low coverage of the surface areas of belts and significantly higher coverage is possible if there is controlled loading of belts. More particularly, the present invention is based on a realisation that controlling the arrangement of particles of a mined material on a conveyor belt of a sorting apparatus so that there is a defined order of the particles on the belt rather than loading a belt and forming a random arrangement of particles can significantly improve the throughput of particles on the belt, particularly in situations where the belt operates as a high capacity belt.

According to the present invention there is provided a method for sorting mined material in a sorting apparatus including a particle feed assembly, a detection assembly, a separation assembly, and a conveyor belt for carrying particles from the feed assembly past the detection assembly to the separation assembly, the method including supplying particles of,a mined material onto the conveyor belt, transporting the particles on the conveyor belt past the detection assembly and assessing the particles, and separating the particles based on the assessment into an accepts stream and a rejects stream at a discharge end of the belt using the separator assembly, and the method including controlling the arrangement of particles so that there is an ordered arrangement of particles on the belt to optimise the throughput of particles through the sorting apparatus.

Controlling the arrangement of particles of mined material on the belt so that there is an ordered arrangement of particles on the belt, for example by forming rows of particles that are closely-spaced apart along the length of the belt, enables individual particles to be more closely spaced along the length and across the width of the belt than would be the case if there was a random distribution of particles on the belt. This makes it possible to optimise the throughput of particles through the sorting apparatus. In the final analysis, in any given situation the minimum possible spacing between particles along the length and across the width of the belt may be based on a range of factors relating to the capability and operation of the sorting apparatus and the characteristics of the mined material. For example, one factor is the resolution and precision of the detection assemblies and the separation assemblies of the sorting apparatus. For example, in a situation where a separation assembly is an air-based system that includes a plurality of air ejectors across the width of a belt at a discharge end of the belt, the spacing between the rows may be determined by the minimum ejector open to open timing. This is approximately 1-2 ms for ejectors known to the applicant and corresponds to approximately a 10 mm row spacing for 6 m/s belt velocities. Similar considerations apply in situations where the separation assembly is based on water ejectors or other types of separators. Another potentially relevant factor is the operating speed of the detection system—with this speed determining the spacing required between successive rows at a given belt speed. Other factors that may be relevant to the minimum possible spacing between particles along the length and across the width of the belt include the size of the particles and the particle size distribution, and the impact of these parameters on exposure and detection times.

The method may include the steps of:

(a) controlling the arrangement of particles so that there is an ordered arrangement of particles on the belt to optimise the throughput of particles through the sorting apparatus,

(b) exposing particles to electromagnetic radiation,

(c) detecting and assessing particles on the basis of composition or texture or another characteristic of the particles, and

(d) separating particles based on the assessment in step (c).

The method may include controlling the arrangement of particles so that the spacing between successive particles along the length of the belt in a line of travel of the belt at a given belt speed is such that the time taken for successive particles to reach the separation assembly is a minimum reactivation time of the separation assembly. In a situation in which the separation assembly includes a plurality of air ejectors in a line across the discharge end of the conveyor belt, the minimum reactivation time is understood to mean the ejector open-to-open timing.

The method may include controlling the arrangement of particles of the mined material on the belt so that particles are closely-spaced across the width of the belt.

The method may include controlling the arrangement of particles of the mined material on the belt so that particles are closely-spaced along the length of the belt.

The method may include controlling the arrangement of particles of the mined material on the belt so that particles are arranged in rows that are closely-spaced along the length of the belt.

The rows may be transverse, such as perpendicular, to a belt travel direction.

The rows may be any suitable profile to optimise throughput and having regard to the operational requirements of the sorting apparatus. The most straightforward arrangement is one in which the rows are linear rows. However, the rows may be non-linear rows. For example, the rows may be V-shaped rows, with the root of the “V” being in the centre of the belt and the arms of the “V” extending outwardly towards the sides of the belt.

The rows may be parallel rows.

Each row may be one particle wide.

Each row may be multiple particles wide.

The method may include controlling the arrangement of particles of the mined material along the length of the belt so that there is a spacing of less than 20 mm between successive rows of particles.

The method may include, controlling the arrangement of particles of the mined material along the length of the belt so that there is a spacing of less than 15 mm between successive rows of particles.

The method may include controlling the arrangement of particles of the mined material along the length of the belt so that there is a spacing of less than 10 mm between successive rows of particles.

The method may include controlling the arrangement of particles of the mined material along the length of the belt so that there is a spacing of 5-15 mm between successive rows of particles.

The method may include controlling the arrangement of particles of the mined material on the belt so that the particles occupy at least 30% of the surface area of the belt.

The method may include controlling the arrangement of particles of the mined material on the belt so that the particles occupy at least 40% of the surface area of the belt.

The method may include controlling the arrangement of particles of the mined material on the belt so that the particles occupy at least 45% of the surface area of the belt.

The method may include controlling the arrangement of particles of the mined material on the belt so that the particles occupy at least 50% of the surface area of the belt.

The method may include supplying the feed ore particles onto the belt at a rate of at least 80 t/h.

The method may include supplying the feed ore particles onto the belt at a rate of at least 100 t/h.

The method may include supplying the feed ore particles onto the belt at a rate of at least 150 t/h.

The method may include supplying the feed ore particles onto the belt at a rate of at least 200 t/h. The method may include supplying the feed ore particles onto the belt at a rate of at least 250 t/h.

The method may include operating the belt at a belt speed of at least 3 m/s.

The method may include operating the belt at a belt speed of at least 5 m/s.

The mined material may be any mined material that contains valuable material, such as valuable metals. Examples of valuable materials are valuable metals in minerals such as minerals that comprise metal oxides or metal sulphides. Specific examples of valuable materials that contain metal oxides are iron ores and nickel laterite ores. Specific examples of valuable materials that contain metal sulphides are copper-containing ores. Other examples of valuable materials are salt and coal.

Particular, although not exclusive, areas of interest to the applicant are mined material in the form of (a) ores that include copper-containing minerals such as chalcopyrite, in sulphide forms and (b) iron ore.

The present invention is particularly, although not exclusively, applicable to sorting low grade mined material.

The term “low” grade is understood herein to mean that the economic value of the valuable material, such as a metal, in the mined material is only marginally greater than the costs to mine and recover and transport the valuable material to a customer.

In any given situation, the concentrations that are regarded as “low” grade will depend on the economic value of the valuable material and the mining and other costs to recover the valuable material from the mined material at a particular point in time. The concentration of the valuable material may be relatively high and still be regarded as “low” grade. This is the case with iron ores.

In the case of valuable material in the form of copper sulphide minerals, currently “low” grade ores are run-of-mine ores containing less than 1.0% by weight, typically less than 0.6 wt. %, copper in the ores. Sorting ores having such low concentrations of copper from barren particles is a challenging task from a technical viewpoint, particularly in situations where there is a need to sort very large amounts of ore, typically at least 10,000 tonnes per hour, and where the barren particles represent a smaller proportion of the ore than the ore that Contains economically recoverable copper.

The term “barren” particles when used in the context of copper-containing ores are understood herein to mean particles with no copper or very small amounts of copper that cannot be recovered economically from the particles.

The term “barren” particles when used in a more general sense in the context of valuable materials is understood herein to mean, particles with no valuable material or amounts of valuable material that cannot be recovered economically from the particles.

The term “particle” is understood herein to mean any suitable size of mined material having regard to materials handling and processing capabilities of the apparatus used to carry out the method and issues associated with detecting sufficient information to make an accurate assessment of the mined material in the particle. It is also noted that the term “particle” as used herein may be understood by some persons skilled in the art to be better described as “fragments”. The intention is to use both terms as synonyms.

Electromagnetic radiation exposure step (b) may include exposing particles of mined material to electromagnetic radiation to cause a change in particles that provides information on properties of the mined material in the particles that is helpful in terms of classifying the particles for sorting and/or downstream processing of the particles and that can be detected by one or more than one sensor or sensor geometry/configuration. The information may include any one or more of composition, mineralogy, hardness, porosity, structural integrity, and texture.

The present invention is not confined to any particular type of electromagnetic radiation. The electromagnetic radiation may be the microwave energy band of the electromagnetic radiation spectrum. Radio frequency radiation and x-ray radiation are two other options in the electromagnetic radiation spectrum.

The electromagnetic radiation may be pulsed or continuous electromagnetic radiation.

The classification of each particle in detection/assessment step (c) may be on the basis of grade of a valuable mineral in the particle. The classification of each particle in step (c) may be on the basis of another property or properties, such as hardness, texture, mineralogy, structural integrity, and porosity. In general terms, the purpose of the classification is to facilitate sorting of the particles and/or downstream processing of the particles. Depending on the particular circumstances of a mine, particular combinations of properties may be more or less helpful in providing useful information for sorting of the particles and/or downstream processing of the particles.

In this regard, it is noted that it will not always be the case that downstream processing is required and the sorting step may produce a marketable product.

It is also noted that when downstream processing is required, there may be more than one processing option, and separation step (d) may comprise separating particles into two or more classes, each of which is suitable for a different downstream processing option.

Detection/assessment step (c) may include detecting the thermal response of each particle to exposure to electromagnetic radiation.

Detection/assessment step (c) may include processing the data for each particle using an algorithm that takes into account the detected data and classifying the particle for sorting and/or downstream processing of the particle.

Detection/assessment step (c) may include thermally analysing the particle to identify valuable material in the particles.

Detection/assessment step (c) may not be confined to sensing the response of particles of the mined material to electromagnetic radiation and may also extend to sensing other properties of the material. For example, step (c) may also extend to the use of any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale. Each of these sensors is capable of providing information on the properties of the mined material in the particles, for example as mentioned in the brackets following the names of the sensors.

The method may include a downstream processing step of comminuting the sorted material from separation step (d) as a pre-treatment step for a downstream option for recovering the valuable mineral from the mined material.

The method may include a downstream processing step of blending the sorted material from separation step (d) as a pre-treatment step for a downstream option for recovering the valuable mineral form the mined material.

The method may include using the sensed data for each particle as feed-forward information for downstream processing options, such as flotation and comminution, and as feed-back information to upstream mining and processing options.

The upstream mining and processing options may include drill and blast operations, the location of mining operations, and crushing operations.

According to the present invention there is also provided an apparatus for sorting mined material, such as mined ore, that includes:

(a) an electromagnetic radiation treatment assembly for exposing particles of the mined material on a particle by particle basis to electromagnetic radiation;

(b) a detection and assessment assembly including (i) plurality of sensors for detecting the response, such as the thermal response, of each particle to electromagnetic radiation and (ii) a processor for analysing the data for each particle, for example using an algorithm that takes into account the detected data, and classifying the particle for sorting and/or downstream processing of the particle, such as heap leaching and smelting;

(c) a separation assembly for separating the particles on the basis of the analysis of the detection and assessment system;

(d) a conveyor belt assembly for transporting particles of mined material successively through the electromagnetic radiation treatment assembly and the detection and assessment assembly to the separation assembly at a downstream discharge end of the belt;

(e) a feed assembly for supplying feed particles onto the belt upstream of the treatment assembly,

and with the feed assembly and/or the belt being adapted to control the arrangement of particles so that there is an ordered arrangement of particles on the belt to optimise the throughput of particles through the apparatus.

The conveyor belt may be a horizontally-disposed,belt.

The feed assembly and/or the belt may be adapted to control the arrangement of particles of mined material on the belt so that the particles are closely-spaced across the width of the belt.

The feed assembly and/or the belt may be adapted to control the arrangement of particles of mined material on the belt so that the particles are closely-spaced along the length of the belt.

The feed assembly and/or the belt may be adapted to control the arrangement of s particles of mined material on the belt so that the particles are arranged in rows that are closely-spaced along the length of the belt.

The rows may be transverse, such as perpendicular, to a belt travel direction.

The rows may be any suitable profile to optimise throughput and having regard to the operational requirements of the sorting apparatus. The most straightforward arrangement is one in which the rows are linear rows. However, the rows may be non-linear rows. For example, the rows may be V-shaped rows, with the root of the “V” being in the centre of the belt and the arms of the “V” extending outwardly towards the sides of the belt.

The rows may be parallel rows.

There are a number of options for establishing rows of particles of the mined material on the belt.

The options include options that relate to the structure and/or operation of the feed assembly. These options include the following options.
A series of members such as fingers at the end of the feed assembly to divide a feed stream of particles, such as a random feed stream, into spaced-apart rows of particles on the belt.
Operating the feed assembly to supply particles onto the belt on an intermittent basis so that there are spacings between successive groups of particles along the length of the belt.
A screen assembly that can be positioned above the belt at a feed location and includes a plurality of apertures that allow particles to pass through the apertures and form a selected arrangement of particles on the belt as the belt passes underneath the screen. The screen assembly may include a single screen or a bank of screens. The apertures in the screen or screens may be formed with a specific size of range of sizes or with a specify shape or range of shapes.
A series of formers for forming the particles into rows on the belt. This arrangement makes it possible to supply the particles onto the belt in a random array and then to order the particles on the belt.

The options also include options that relate to the structure and/or operation of the belt. These options include the following options.
A series of formations such as ridges, nodules, protrusions, channels, ribs, depressions, divots, and cups, that are adapted to distribute particles supplied onto the belt into an ordered arrangement on the belt. The fingers may be made from flexible and high wear resistant materials, such as urethane secured to the belt or manufactured as part of the main belt itself.
Providing the surface of the belt with a “sticky” surface in selected areas of the belt for adhering particles to the belt to thereby distribute particles supplied onto the belt into an ordered arrangement on the belt. The sticky surface may be a removable surface coating, in which case a new sticky surface arrangement may be applied as required given different feed material and sorting apparatus characteristics. Depending on the circumstances, it may be necessary to regenerate the sticky surface.
A second belt (such as an overhead belt) with forming ribs or channels or other members that are adapted to distribute particles supplied onto the conveyor belt into an ordered arrangement on the conveyor belt.

The conveyor belt may be a flat belt, i.e. a belt that does not have any pockets or other formations for receiving and retaining particles on the belt.

According to the present invention there is also provided a method for recovering valuable material, such as a valuable metal, from mined material, such as mined ore, that comprises sorting mined material according to the method described above and thereafter processing the particles containing valuable material and recovering valuable material.

The processing options for the sorted particles may be any suitable options, such as smelting and leaching options.

The downstream heap leaching and smelting operations may be carried out at the mine or the particles could be transported to other locations for the heap leaching and smelting operations.

### BRIEF DESCRIPTION OF THE DRAWINGS

Notwithstanding any other forms which may fall within the scope of the apparatus and method as set forth in the Summary, specific embodiments will now be described, by way of example only, with reference to the accompanying drawings in which:

FIG. 1(a) is a top plan view that illustrates a random arrangement of particles of a mined material on a conveyor belt;

FIG. 1(b) is a top plan view that illustrates one embodiment of an ordered arrangement of particles of a mined material on a conveyor belt in accordance with the method and the apparatus of the present invention;

FIG. 1(c) is a top plan view that illustrates another embodiment of an ordered arrangement of particles of a mined material on a conveyor belt in accordance with the method and the apparatus of the present invention;

FIG. 1(d) is a top plan view that illustrates another, although not the only other, embodiment of an ordered arrangement of particles of a mined material on a conveyor belt in accordance with the method and the apparatus of the present invention; and

FIG. 2 is a schematic diagram which illustrates one embodiment of a sorting apparatus in accordance with the present invention.

### DESCRIPTION OF EMBODIMENT(S)

The embodiments are described in the context of a method of recovering a valuable metal in the form of copper from low grade copper-containing ores in which the copper is present in copper-containing minerals such as chalcopyrite and the ores also contain non-valuable gangue. The objective of the method in the embodiments is to identify particles of mined material containing amounts of copper-containing minerals above a certain grade and to sort these particles from the other particles and to process the copper-containing particles using the most effective and viable option to recover copper from the particles.

It is noted that, whilst the following description does not focus on the downstream processing options, these options are any suitable options ranging from smelting to leaching.

It is also noted that the present invention is not confined to copper-containing ores and to copper as the valuable material to be recovered. In general terms, the present invention provides a method of sorting any mined materials which exhibit different heating responses when exposed to electromagnetic radiation. The mined materials may be metalliferous materials and non-metalliferous materials. Iron-containing and copper-containing ores are examples of metalliferous materials. Coal is an example of a non-metalliferous material.

It is also noted that the present invention is not confined to using a grade threshold as the sole basis for sorting the particles and the invention extends to considering other properties that are indicators of the suitability of particles for downstream recovery processes.

FIG. 1(a) is a top plan view that illustrates a typical random arrangement of particles 1 of a mined ore on a belt conveyor 5 of a sorting apparatus known to the applicant. The Figure illustrates the particles immediately upstream of a separator assembly 29. In use of the arrangement shown in the Figure, the belt conveyor 5 carries particles on the belt from the left to the right side of the Figure. The air separator assembly is in the form of a plurality of air-activated ejectors arranged in a line across the end. Each air ejector is operable to selectively deflect particles in a section of the width of the belt conveyor 5 in response to upstream detection and assessment of the particles. Each air ejector is operable independently of the other air ejectors. Deflected particles become one stream of particles and non-deflected particles become another stream of particles, namely an accepts stream and a rejects stream. The spacing between adjacent particles along and across the width of the belt is variable, with a result that typically the particles occupy no more than 10-15% of the belt area. This is not an optimum arrangement in terms of throughput of the sorting apparatus.

FIG. 1(b) is a top plan view that illustrates one embodiment of an arrangement of particles 1 of a mined ore on the conveyor belt.5 in a sorting apparatus in accordance with the method and the apparatus of the present invention. The Figure illustrates the particles immediately upstream of the separator assembly 29 of the sorting apparatus. In accordance with the present invention the arrangement of particles on the belt 5 is controlled so that there is a defined order of the particles 1 along the length and optionally across the width of the belt 5 rather than the random arrangement shown in FIG. 1(a). The controlled order of the particles 1 makes it possible to increase the coverage of the particles 1 on the belt 5 to at least 30%. This makes it possible to significantly improve the throughput of particles on the belt, particularly in situations where the belt operates as a high capacity belt. In the arrangement shown in FIG. 1(b) the particles 1 are arranged in parallel linear rows 21 that are a single particle wide and extend perpendicularly to the belt direction, identified by the arrow in the Figure. There is a wide range of possible ordered arrangements of particles on the belt. Several other possible ordered arrangements are shown in FIGS. 1(c) and 1(d). In the FIG. 1(c) arrangement, the linear rows of particles extend transversely to the belt direction, in this instance at an angle approximately 60°. In the FIG. 1(d) arrangement, the rows of particles are in the form of V-shapes.

In each of these arrangements shown in FIGS. 1(a) to 1(d), the spacing between successive rows and between adjacent particles in each row are the minimum spacings possible having regard to operational requirements of the sorting apparatus in order to maximise the coverage of the belt and hence the throughput of the sorting apparatus. These operational requirements include the operational requirements of detection and separation assemblies of the sorting apparatus and other factors, including particle size and particle size distribution, discussed above.

There are a number of options for establishing a controlled order of the particles 1 on the belt of the type shown in FIG. 1(b). The options include options that relate to the structure and/or operation of a feed assembly for supplying particles 1 onto the belt 5. The options also include options that relate to the structure of the belt 5. A number of examples of these options are mentioned above.

FIG. 2 illustrates one embodiment of a sorting apparatus in accordance with the present invention

With reference to FIG. 2, a feed material in the form of ore particles 1 that have been crushed by a primary crusher (not shown) to a particle size of 10-25 cm are supplied via a feed assembly 3 onto a conveyor belt 5 and the belt 5 transports the particles 1 through a microwave radiation treatment assembly 7 that includes an exposure chamber. The feed assembly 3 and/or the belt 5 are formed and/or operated as described by way of example above to establish a controlled order of the particles 1 on the belt, for example of the type shown in FIG. 1(b).

The particles 1 on the belt 5 are exposed to microwave radiation on a particle by particle basis as they move through the exposure chamber of the microwave radiation treatment assembly 7. The microwave radiation may be either in the form of continuous or pulsed radiation. The microwave radiation may be applied at a power density below that which is required to induce micro-fractures in the particles. In any event, the microwave frequency and microwave intensity and the particle exposure time and the other operating parameters of the microwave treatment assembly 7 are selected having regard to the information that is required. The required information is information that is helpful in terms of classifying the particular mined material for sorting and/or downstream processing of the particles. In any given situation, there will be particular combinations of properties, such as grade, mineralogy, hardness, texture, structural integrity, and porosity, that will provide the necessary information to make an informed decision about the sorting and/or downstream processing of the particles, for example, the sorting criteria to suit a particular downstream processing option.

While passing through the microwave treatment assembly 7, radiation from the particles 1 is detected by high resolution, high speed infrared imagers 13 which capture thermal images of the particles. While one thermal imager is sufficient, two or more thermal imagers may be used for full coverage of the particle surface.

In addition, one or more visible light cameras (not shown) capture visible light images of the particles to allow determination of particle size. From the number of detected hot spots (pixels), temperature, pattern of their distribution and their cumulative area, relative to the size of the particle, an estimation of the grade of observed rock particles can be made. This estimation may be supported and/or more mineral content may be quantified by comparison of the data with previously established relationships between microwave induced thermal properties of specifically graded and sized rock particles.

It is noted that there may be a range of other sensors (not shown) positioned within and/or downstream of the microwave exposure chamber depending on the required information to classify the particles for sorting and/or downstream processing options. These sensors may include any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale.

Images collected by the thermal imagers and the visible light sensors (and any other sensors) are processed, for example, using a computer 9 equipped with image processing software. The software is designed to process the sensed data to classify the particles for sorting and/or downstream processing options. In any given situation, the software may be designed to weight different data depending on the relative importance of the properties associated with the data.

In one mode of operation the thermal analysis is based on distinguishing between particles that are above and below a threshold temperature. The particles can then be categorised as “hotter” and “colder” particles. The temperature of a particle is related to the amount of copper minerals in the particle. Hence, particles that have a given size range and are heated under given conditions will have a temperature increase to a temperature above a threshold temperature “x” degrees if the particles contain at least “y” wt. % copper. The threshold temperature can be selected initially based on economic factors and adjusted as those factors change. Barren particles will generally not be heated on exposure to radio frequency radiation to temperatures above the threshold temperature.

Once the thermal and visual light analysis is completed by the computer 9 and each particle is classified, the particles are separated by a separator assembly 29 that includes a plurality of air ejectors at spaced intervals across the width of the belt 5 into one of two (or possibly more) categories.

In the present instance, the primary classification criteria is the grade of the copper in the particle, with particles above a threshold grade being separated into one collection bin 19 and particles below the threshold grade being separated into the other bin 17. The valuable particles in bin 19 are then processed to recover copper from the particles. For example, the valuable particles in the bin 19 are transferred for downstream processing including milling and flotation to form a concentrate and then processing the concentrate to recover copper.

The particles are separated by being projected from the end of the conveyor belt 5 and being deflected selectively by compressed air jets (or other suitable fluid jets, such as water jets) as the particles move in a free-fall trajectory from the belt 5 and thereby being sorted into two streams that are collected in the bins 17, 19. The thermal analysis identifies the position of each of the particles on the conveyor belt 5 and the air jets are activated a pre-set time after a particle is analysed as a particle to be deflected.

The particles in bin 17 may become a by-product waste stream and are disposed of in a suitable manner. This may not always be the case. The particles have lower concentrations of copper minerals and may be sufficiently valuable for recovery. In that event the colder particles may be transferred to a suitable recovery process, such as leaching.

The above-described embodiment of the present invention makes it possible to significantly increase sorting apparatus throughput compared to known sorting apparatus. The application of individual particle sorting through sorting units being developed by the applicant relies on a high throughput of particles of mined material. Embodiments of these sorting units that were being developed before the present invention support feed rates up to 100-120 t/h/m belt width at 10-15% occupancy (by area). The above-described and other embodiments of the present invention are expected to increase this coverage conservatively to at least 50%. As a consequence, the present invention has potential to intensify the process by a factor of 3-5 and hence deliver required economies of scale.

Whilst a number of specific apparatus and method embodiments have been described, it should be appreciated that the apparatus and method may be embodied in many other forms.

By way of example, whilst the embodiment includes exposing the particles to be sorted to microwave radiation, the present invention is not so limited and extends to the use of any other suitable electromagnetic radiation. Suitable electromagnetic radiation may include X-ray and radio frequency radiation.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A method for sorting mined material in a sorting apparatus including a particle feed assembly, a detection assembly, a separation assembly, and a conveyor belt for carrying particles from the feed assembly past the detection assembly to the separation assembly, the method including supplying particles of a mined material onto the conveyor belt, transporting the particles on the conveyor belt past the detection assembly and assessing the particles, and separating the particles based on the assessment into an accepts stream and a rejects stream at a discharge end of the belt using the separator assembly, and the method including controlling the arrangement of particles so that there is an ordered arrangement of particles on the belt to optimise the throughput of particles through the sorting apparatus.

2. The method defined in claim 1 including the steps of:
(a) controlling the arrangement of particles of mined material so that there is an ordered arrangement of particles on the belt to optimise the throughput of particles through the sorting apparatus,
(b) exposing particles to electromagnetic radiation,
(c) detecting and assessing particles on the basis of composition or texture or another characteristic of the particles, and
(d) physically separating particles based on the assessment in step (c).

3. The method defined in claim 1 including controlling the arrangement of particles so that the spacing between successive particles along the length of the belt in a line of travel of the belt at a given belt speed is such that the time taken for successive particles to reach the separation assembly is a minimum reactivation time of the separation assembly.

4. The method defined in claim 1 including controlling the arrangement of particles of the mined material on the belt so that particles are closely-spaced across the width of the belt.

5. The method defined in claim 1 including controlling the arrangement of particles of the mined material on the belt so that particles are closely-spaced along the length of the belt.

6. The method defined in claim 1 including controlling the arrangement of particles of the mined material on the belt so that particles are arranged in rows that are closely-spaced along the length of the belt.

7. The method defined in claim 6 wherein the rows are transverse to a belt travel direction.

8. The method defined in claim 6 wherein the rows are linear rows.

9-12. (canceled)

13. The method defined in claim 1 including controlling the arrangement of particles of the mined material on the belt so that the particles occupy at least 30% of the surface area of the belt.

14. The method defined in claim 1 including supplying the feed ore particles onto the belt at a rate of at least 80 t/h.

15-16. (canceled)

17. The method defined in claim 1 wherein electromagnetic radiation exposure step (b) includes exposing particles to electromagnetic radiation to cause a change in particles of a mined material that provides information on properties of the mined material in the particles that is helpful in terms of classifying the particles for sorting and/or downstream processing of the particles and that can be detected by one or more than one sensor or sensor geometry/configuration.

18. The method defined in claim 1 wherein detection/assessment step (c) includes detecting the thermal response of each particle to exposure to electromagnetic radiation.

19. An apparatus for sorting mined material that includes:
(a) an electromagnetic radiation treatment assembly for exposing particles of the mined material on a particle by particle basis to electromagnetic radiation;
(b) a detection and assessment assembly including (i) plurality of sensors for detecting the response of each particle to electromagnetic radiation and (ii) a processor for analysing the data for each particle and classifying the particle for sorting and/or downstream processing of the particle;
(c) a separation assembly for separating the particles on the basis of the analysis of the detection and assessment system;
(d) a conveyor belt assembly for transporting particles of mined material successively through the electromagnetic radiation treatment assembly and the detection and assessment assembly to the separation assembly at a downstream discharge end of the belt;
(e) a feed assembly for supplying feed particles onto the belt upstream of the treatment assembly,
and with the feed assembly and/or the belt being adapted to control the arrangement of particles so that there is an ordered arrangement of particles on the belt to optimise the throughput of particles through the apparatus.

20. The apparatus defined in claim 19 wherein the feed assembly and/or the belt are adapted to control the arrangement of particles of mined material on the belt so that the particles are closely-spaced across the width of the belt.

21-24. (canceled)

25. The apparatus defined in claim 19 wherein the feed assembly is adapted to control the arrangement of particles of mined material on the belt.

26. The apparatus defined in claim 25 wherein the feed assembly includes a series of members such as fingers at the end of the feed assembly to divide a feed stream of particles into spaced-apart rows of particles on the belt.

27. The apparatus defined in claim 25 wherein the feed assembly is adapted to operate to supply particles onto the belt on an intermittent basis so that there are spacings between successive groups of particles along the length of the belt.

28-33. (canceled)

34. The apparatus defined in claim 19 wherein the conveyor belt is a flat belt, i.e. a belt that does not have any pockets or other formations for receiving and retaining particles on the belt.

35. The apparatus defined in claim 19 wherein the conveyor belt is a horizontally-disposed belt.

36. A method for recovering valuable material, such as a valuable metal, from mined material, such as mined ore, that comprises sorting mined material according to the method defined in claim 1 and thereafter processing the particles containing valuable material and recovering valuable material.
